(19) United States
(12) Patent Application Publication
(10) Pub. No.: US 2019/0289689 A1
(43) Pub. Date: Sep. 19, 2019

(54) LUMINAIRE, LIGHTING SYSTEM, AND LIGHTING CONTROL METHOD

(71) Applicant: PANASONIC INTELLECTUAL PROPERTY MANAGEMENT CO., LTD., Osaka (JP)

(72) Inventors: Koji UENOYAMA, Kyoto (JP); Shinichi MURAKAMI, Osaka (JP)

(21) Appl. No.: 16/298,751

(22) Filed: Mar. 11, 2019

(30) Foreign Application Priority Data
Mar. 15, 2018 (JP) 2018-048521

(51) Int. Cl. H05B 33/08; H05B 37/02

(52) U.S. Cl. CPC H05B 33/0863; H05B 33/0854; H05B 33/0872; H05B 37/0254

(57) ABSTRACT

A luminaire includes: a light source configured to emit light in a plurality of different colors; a controller that controls a color of the light emitted by the light source; an operation panel that receives information indicating a second color of light to be emitted by the light source; and an obtainer that obtains from an external device first information indicating a first color of light to be emitted by the light source. The controller stores second information including the information indicating the second color of light to be emitted by the light source, received by the operation panel. The controller generates third information indicating a third color which is a mixture of the first color of light indicated by the first information and the second color of light indicated by the information included in the second information, and causes the light source to emit light using the third information.

### CROSS REFERENCE TO RELATED APPLICATION

This application claims the benefit of priority of Japanese Patent Application Number 2018-048521 filed on Mar. 15, 2018, the entire content of which is hereby incorporated by reference.

### BACKGROUND

### 1. Technical Field

The present disclosure relates to a luminaire, a lighting system, and a lighting control method.

### 2. Description of the Related Art

Conventionally, choreographing of light emitted by a luminaire has been generally performed by, for example, matching a lighting state of a room with a feeling of a person. The luminaire uses information received from a control terminal to emit light in such a manner that a color of light indicated by the information is reproduced. For example, a lighting system including a controller which stores color rendering brightness information about color rendering and brightness, provides the color rendering brightness information to a luminaire, and causes the luminaire to perform multiple kinds of lighting in which the color rendering distribution and the brightness distribution vary is known (for example, see Japanese Unexamined Patent Application Publication No. 2006-286428).

### SUMMARY

For the conventional lighting system, a more simplified configuration of settings is demanded when the lighting state is implemented.

In view of this, the present disclosure has an object to provide a luminaire, a lighting system, and a lighting control method that can simplify the configuration of settings for choreographed lighting.

In order to achieve the object described above, a luminaire according to one aspect of the present disclosure is a luminaire that produces choreographed lighting, the luminaire including: a light source configured to emit light in a plurality of different colors; a controller that controls a color of the light emitted by the light source; a user interface that receives information indicating a second color of light to be emitted by the light source; and an obtainer that obtains from an external device first information indicating a first color of light to be emitted by the light source, in which the controller: stores second information including the information indicating the second color of light to be emitted by the light source, received by the user interface; generates third information indicating a third color which is a mixture of the first color of light indicated by the first information and the second color of light indicated by the information included in the second information; and causes the light source to emit light using the third information.

In order to achieve the object described above, a lighting system according to one aspect of the present disclosure includes a plurality of luminaires, and a control terminal that controls the plurality of luminaires.

In order to achieve the object described above, a lighting control method according to one aspect of the present disclosure is a lighting control method of producing choreographed lighting, the lighting control method including: receiving a color of light to be emitted by a light source; obtaining first information from an external device; storing second information indicating the color of light received; mixing a first color of light indicated by the first information with a second color of light indicated by the second information to generate third information; and causing the light source to emit light using the third information.

According to the present disclosure, it is possible to simplify the configuration of settings for choreographed lighting.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a block diagram of a lighting system according to an embodiment;

FIG. 2 is a perspective view of a luminaire according to the embodiment;

FIG. 3 is a cross-sectional view of the luminaire according to the embodiment, taken at line III-III in FIG. 2;

FIG. 4 is a block diagram of the luminaire according to the embodiment;

FIG. 5 schematically illustrates an operation panel on the luminaire according to the embodiment and the colors of light corresponding to first through seventh light emission buttons;

FIG. 6A illustrates an example of generating the third information;

FIG. 6B illustrates another example of generating the third information;

FIG. 7 illustrates the case in which magenta light is cancelled from the second information;

FIG. 8 is a flow chart of operations for generating the second information, performed by the luminaire according to the embodiment;

FIG. 9 is a flow chart of operations for generating the third information, performed by the luminaire according to the embodiment;

FIG. 10 is a block diagram of a lighting system according to a variation; and

FIG. 11 is a block diagram of a lighting system according to another variation.

### DETAILED DESCRIPTION OF THE EMBODIMENT

The following describes an embodiment with reference to the drawings. The embodiment described below shows a preferred, specific example of the present disclosure. The numerical values, shapes, materials, elements, the arrangement and connection of the elements, etc., indicated in the following embodiment are mere examples, and therefore do not intend to limit the present disclosure. Therefore, among elements in the following embodiment, those not recited in any of the broadest, independent claims are described as optional elements.

Moreover, “approximately” means, for example in the case of “approximately parallel,” not only exactly parallel, but what would be recognized as substantially parallel as well. For example, the phrase “approximately parallel to xx” includes a line inclined at a few degrees with respect to “xx”.

Note that the drawings are represented schematically and are not necessarily precise illustrations. Additionally, like reference signs indicate like elements in the drawings, and repeated descriptions thereof are omitted or simplified.

Hereinafter, a luminaire, a lighting system, and a lighting control method according to an embodiment of the present disclosure will be described.

### EMBODIMENT

### (Configuration)

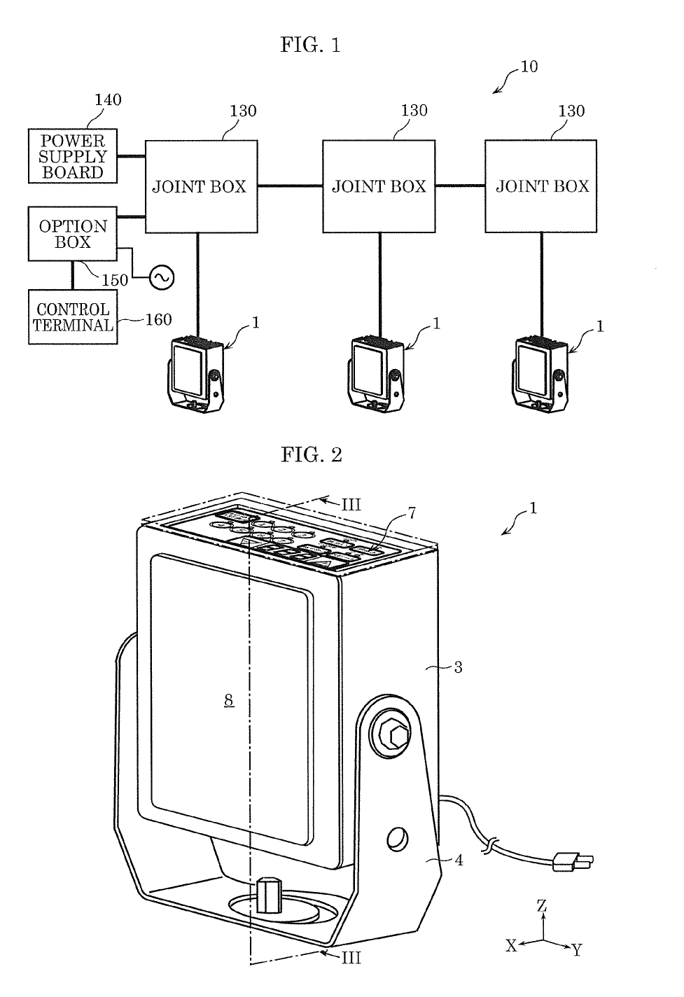

FIG. 1 is a block diagram of lighting system 10 according to an embodiment.

Lighting system 10 includes control terminal 160, power supply board 140, option box 150, and two or more luminaires 1.

Control terminal 160 is electrically connected to two or more luminaires 1 via option box 150, joint box 130, etc., and can individually or collectively control two or more luminaires 1. Control terminal 160 receives a dimming signal provided from outside. In other words, control terminal 160 includes a control panel operated by a user, and a control circuit that provides each of luminaires 1 with a control signal for dimming and color adjusting of the light emitted from luminaire 1. The control signal may be a signal of a standardized communication protocol such as DMX, or a pulse with modulation (PWM) signal having a different duty cycle according to a color adjustment ratio. Furthermore, control terminal 160 may obtain the control signal from another device, and provide each of luminaires 1 with the obtained control signal.

Power supply board 140 is configured to convert an alternate current supplied from a utility power source into a direct current. Power supply board 140 supplies power to each of luminaires 1 via joint box 130.

Option box 150 is a device that transmits the first information to each of luminaires 1. For example, option box 150 includes a weather sensor for sensing weather such as rainy, windy, sunny, cloudy, or snowy, a clock for measuring a time and date, and the like to sense the surrounding weather and/or calculate the season. Specifically, option box 150 senses the weather such as rainy, windy, sunny, cloudy, or snowy, and/or calculates the season such as spring, summer, autumn, or winter. Option box 150 is one example of an external device. For example, only when it is raining and/or windy, Option box 150 transmits the first information to each of luminaires 1.

Option box 150 includes a table that associates the weather and the season with a color of light to be emitted from light source 5. Option box 150 generates, based on the table, the first information indicating the color of light to be emitted by light source 5 corresponding to the weather sensed by the weather sensor and the season calculated by the clock, and provides the first information to each of luminaries 1. The first information is information indicating the color of light associated with the weather and the season in advance. It should be noted that the first information is not limited to the weather and the season. For example, the first information may include information indicating a color of light associated with humidity and/or temperature.

Option box 150 is electrically connected to control terminal 160 and joint box 130. Furthermore, option box 150 receives power from the utility power source.

It should be noted that option box 150 may obtain, from another luminaire, the first information indicating the lighting state of the another luminaire, and provide the obtained first information to each of luminaires 1. Furthermore, option box 150 may include a control unit configured to generate the first information. Furthermore, option box 150 may include a temperature sensor, a humidity sensor, etc.

Each of luminaires 1 is a device that can produce choreographed lighting by emitting light in different colors in different predetermined periods of time. Luminaire 1 is, for example, a flood light or down light. For example, luminaire 1 is attached to a part of a building such as a facility. Each luminaire 1 is connected to control terminal 160 and power supply board 140 via at least one joint box 130.

Hereinafter, each luminaire 1 has the same structure, and thus the structure of one luminaire 1 will be described unless otherwise stated.

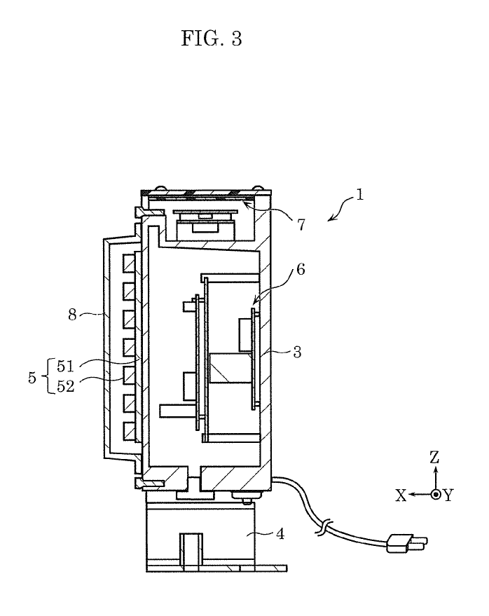

FIG. 2 is a perspective view of luminaire 1 according to this embodiment. FIG. 3 is a cross-sectional view of luminaire 1 according to the embodiment, taken at line III-III in FIG. 2.

X, Y, and Z directions are shown in FIG. 2 and FIG. 3. The direction in which luminaire 1 emits light corresponds to the X axis positive direction, the direction from first light emission button 71 toward brightness button 174 corresponds to the Y axis positive direction, and the direction in which operation panel 7 is located relative to light source 5 corresponds to the Z axis positive direction. The directions shown in FIG. 2 correspond to the directions shown in FIG. 3. This also applies to the drawings subsequent to FIG. 3, excluding the drawings in which the X, Y, and Z directions are not indicated.

Luminaire 1 includes housing 3, attachment frame 4, light source 5, controller 6, operation panel 7, light-transmissive panel 8, and a power supply unit.

Housing 3 is a cuboid box. Housing 3 houses light source 5, controller 6, operation panel 7, and the power supply unit. In housing 3, light source 5 is disposed at the X axis positive direction end, and operation panel 7 is disposed at the Z axis positive direction end. Light-transmissive panel 8 is disposed further in the X axis positive direction than light source 5 on housing 3.

Attachment frame 4 is a component for attaching luminaire 1 to a part of a building. Attachment frame 4 is U-shaped in a view of luminaire 1 in the X axis positive direction. Attachment frame 4 is fixed to housing 3 so as to sandwich housing 3 on both Y axis sides. Attachment frame 4 is rotatable relative to housing 3. For example, when luminaire 4 is fixed to a part of a building, housing 3 rotates relative to attachment frame 4. This makes it possible to change the direction in which luminaire 1 emits light.

Light source 5 is a module capable of emitting light in a plurality of different colors, including, for example, red, yellow, green, cyan, blue, magenta, and white. Light source 5 includes substrate 51 and a plurality of light-emitting devices 52.

Substrate 51 is a mounting substrate for mounting light-emitting devices 52, and is, for example, a ceramics substrate, resin substrate, or metal-based substrate covered with an electrical insulation film. In this embodiment, substrate 51 is a low temperature co-fired ceramic (LTCC) package substrate. For example, substrate 51 is a plate-shaped substrate having a flat surface with a rectangular plan-view shape.

Substrate 51 is mounted with a plurality of light-emitting devices 52. Substrate 51 is fixed to the X axis positive direction surface of housing 3 while oriented approximately parallel to the YZ plane.

Light-emitting devices 52 are elements that emit light which is ultimately emitted from luminaire 1. In this embodiment, each light-emitting device 52 is a light-emitting diode (LED) light source, which is a light-emitting module including an LED, that radially emits predetermined light. The plurality of light-emitting devices 52 include red LED chips, green LED chips, and blue LED chips. The light from the red LED chips, green LED chips, and blue LED chips combine to produce various colors of light. For example, each light-emitting device 52 is an LED chip that includes a chip-on-board (COB) type LED and is mounted on substrate 51.

In this embodiment, the plurality of light-emitting devices 52 are mounted on substrate 51 while oriented to emit light in the X axis positive direction. It should be noted that since the orientation in which the plurality of light-emitting devices 52 emit light changes depending on the orientation of housing 3 relative to attachment frame 4, the orientation is not limited to the example given in this embodiment.

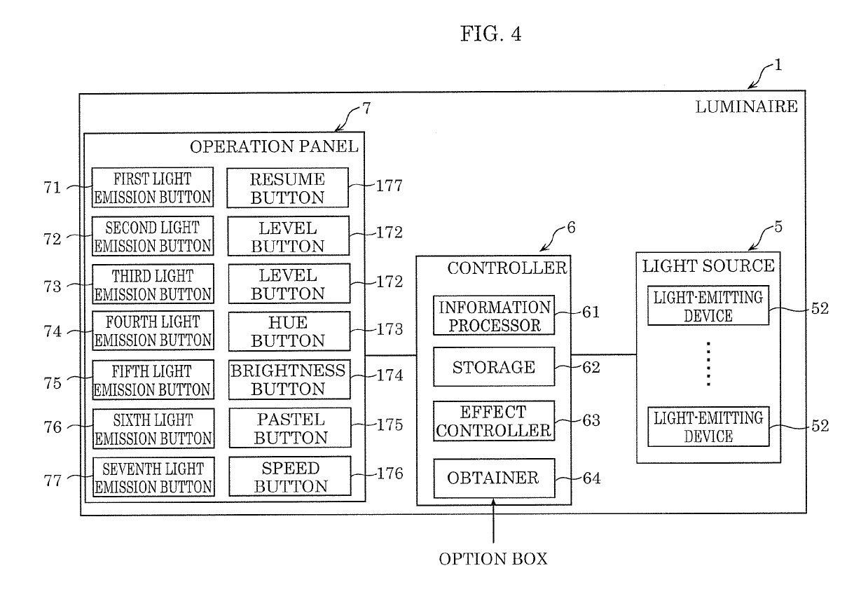

FIG. 4 is a block diagram of luminaire 1 according to the embodiment.

As illustrated in FIG. 4, controller 6 includes information processor 61, storage 62, effect controller 63, and obtainer 64.

Information processor 61 generates the second information each time information processor 61 receives a user's operation via operation panel 7, and stores the generated second information in storage 62. The second information associates the color of light corresponding to the selected light emission button with a sequence value indicating the sequential order in which the light emission button was selected. Stated differently, when information processor 61 receives a string of operations made via operation panel 7, information processor 61 associates the colors of light of light source 5 assigned to operation panel 7 with the sequential order of the selections made on operation panel 7, and stores, in storage 62, the sequential order in which the operations made each time an operation is made. For example, when a red light emission button and a magenta light emission button are selected in the stated order, information processor 61 stores in storage 62 the second information for causing light source 5 to emit light in the stated order of red and magenta.

Furthermore, if a new light emission button, e.g. a green light emission button, is selected while light-emitting devices 52 repeatedly emit red light and magenta light in the stated order, a sequence value immediately subsequent to the sequence value of the light emission button for magenta selected last in the stored sequential order is assigned to the color corresponding to the newly selected green light emission button. Then, light-emitting devices 52 repeatedly emit red light, magenta light, and green light in the stated order Each light emission button is one example of a button.

The second information includes a parameter indicating the sequential order in which the light emission buttons are selected, expressed as sequence values for colors corresponding to the light emission buttons. The second information is, for example, information for causing light-emitting devices 52 to repeatedly emit red light, magenta light, and green light in the stated order. One iteration of such a selection of colors of light is also referred to as one cycle.

The second information also includes a parameter for controlling lighting not only in the sequential order in which the selected colors of light are selected, but also in other aspects of the light emitted by light source 5, such as brightness, hue, vividness, and transition period. The selected colors of light mean the colors of light corresponding to the selected light emission buttons. A selected light emission button means a pressed button, and light source 5 emits light in the color corresponding to that light emission button.

When a light emission button is pressed, information processor 61 determines whether the same light emission button has already been selected. When information processor 61 determines that the same light emission button has already been selected, information processor 61 cancels that light emission button stored in storage 62. Light emission button cancellation will be described later.

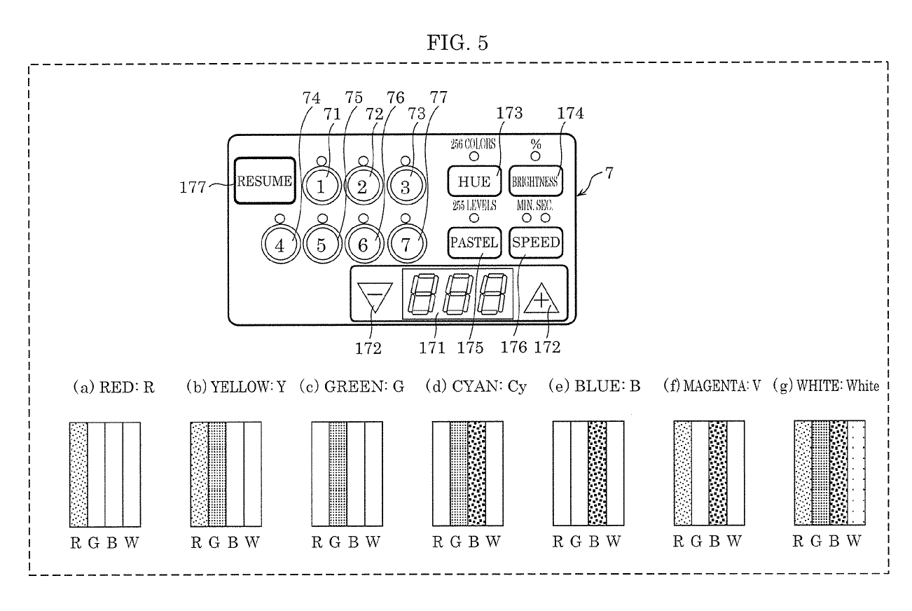

FIG. 5 schematically illustrates operation panel 7 on luminaire 1 according to the embodiment and the colors of light corresponding to first light emission button 71 through seventh light emission button 77.

As illustrated in FIG. 5, information processor 61 determines whether sequence value n of the selected light emission button is less than or equal to a maximum sequence value m. Information processor 61 associates a sequence value n with each light emission button that is selected. For example, when first light emission button 71, sixth light emission button 76, and third light emission button 73 (to be described later) are selected in the stated order, information processor 61 associates the sequence value n=1 with red light corresponding to first light emission button 71, sequence value n=2 with magenta light corresponding to sixth light emission button 76, and sequence value n=3 with green light corresponding to third light emission button 73. Information processor 61 generates the second information associating red light, magenta light, and green light with the stated sequential order as a single cycle. Furthermore, if a new light emission button is selected at any time while the color of light is reproduced according to the second information, information processor 61 provides the next sequence value to the newly selected light emission button.

In response to a user operating operation panel 7, information processor 61 stores, in storage 62, a second value to be described later. The second value indicates at least one of a brightness, hue, vividness, and transition period of the light emitted by light source 5.

When changing the setting for any one of the brightness, hue, vividness, and transition period of the light, information processor 61 once again determines whether operation panel 7 has been operated within a predetermined period beginning when operation panel 7 was last operated. If operation panel 7 is not operated within the predetermined period or longer, it is assumed that the user is finished with making operations.

Accordingly, when changing the setting for any one of the brightness, hue, vividness, and transition period of the light, if operation panel 7 is not operated within the predetermined period or longer, information processor 61 finalizes the values displayed on display 171 which displays values indicating the current settings. In this embodiment, the predetermined period is set to, for example, three minutes, but not limited to this.

Information processor 61 updates a predetermined value included in the second information. Here, a predetermined value indicates at least one of a brightness level, hue level, vividness level, and transition period of light, and is either the first or second value. It should be noted that the determination of whether the predetermined period has elapsed or not may be implemented using a clock that measures time.

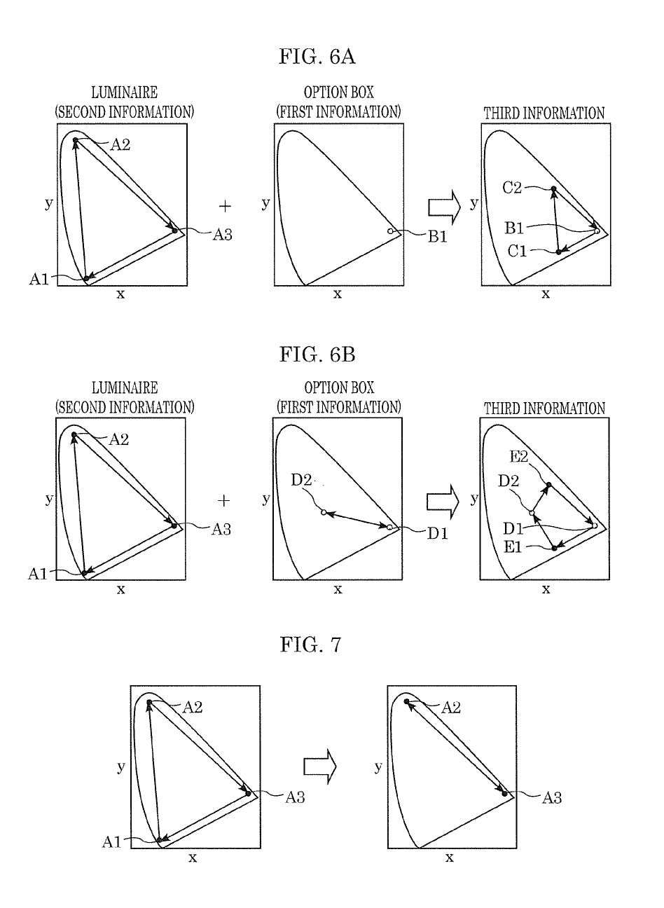

Information processor 61 mixes the color of light indicated by the first information with the color of light indicated by the second information to generate third information, and causes light source 5 to emit light using the third information. The generating of the third information is described with reference to FIG. 6A and FIG. 6B.

FIG. 6A illustrates an example of generating the third information. FIG. 6B illustrates another example of generating the third information.

As illustrated in FIG. 6A and FIG. 6B, information controller 61 mixes the second information generated through operation panel 7 of luminaire 1 and the first information obtained from option box 150. When the color of light indicated by the first information and the color of light indicated by the second information are mixed, information controller 61 mixes the colors using additive color mixing, subtractive color mixing, and a combination thereof.

The second information is represented as multiple points in a chromaticity diagram each of which defines the color of light to be emitted by light source 5. The second information includes three points, but is not limited to this. The second information may include two or less, or four or more points. x is an integer greater than or equal to 1.

As illustrated in FIG. 6A, when the color of light indicated by the first information is mixed with the colors of light indicated by the second information, information controller 61 generates the third information in which a position of at least one of the points of the second information in the chromaticity diagram is changed. Specifically, the second information of FIG. 6A includes three points, i.e. A1, A2, and A3, in the chromaticity diagram. The first information includes one point, i.e. B1, in the chromaticity diagram. It is assumed that the position of point B1 is substantially the same as the position of point A3. In this case, information processor 61 shifts at least two points A1 and A2 to the points C1 and C2, respectively, to generate the third information including the points C1, C2, and B1 (=A3). These positions mean positions in the chromaticity diagram, and indicate the colors of light. The points B1, C1, and C2 are each one example of a first point or a second point. For example, when the point C1 is one example of the first point, the point C2 or the point B1 is one example of the second point.

The position of point B1 indicated by the first information is the same as the position of point A3 of the second information, and thus information processor 61 does not shift the point A3 and shifts the points A1 and A2 to the points C1 and C2, respectively, to approach the point A3. Thus, information processor 61 changes the second information according to the first information to generate the third information.

As illustrated in FIG. 6B, when the colors of light indicated by the first information are mixed with the colors of light indicated by the second information, information controller 61 generates the third information in which the number of the points of the second information in the chromaticity diagram is changed. Specifically, the second information of FIG. 6B also includes three points, i.e. A1, A2, and A3, in the chromaticity diagram. The first information includes two points, i.e. D1 and D2, in the chromaticity diagram. It is assumed that the position of point D2 is the same as the position of point A3. In this case, information processor 61 shifts at least two points A1 and A2 to the points E1 and E2, respectively, to generate the third information including the points E1, E2, D1 (=A3), and D2. These positions mean positions in the chromaticity diagram, and indicate the colors of light. The points D1, D2, E1, and E2 are each one example of a first point or a second point.

The position of point D1 indicated by the first information is the same as the position of point A3 of the second information, and thus information processor 61 does not shift the point A3 and shifts the points A1 and A2 to the points E1 and E2, respectively, to approach the point A3. Information processor 61 does not also shift the position of point D1 to cause light source 5 to emit light in the color represented by the position of point D1. Thus, information processor 61 changes the second information according to the first information to generate the third information. Information processor 61 stores the generated third information in storage 62. In view of this, the first information, the second information, and the third information each indicate a sequence of color changes in the chromaticity diagram, which defines the color of light emitted by light source 5. In luminaire 1, the color of light emitted by light source 5 is changed according to the generated third information.

It should be noted that in FIG. 6A and FIG. 6B, the first information and the second information in the chromaticity diagram are each one example, and not limited to this.

As illustrated in FIG. 4, storage 62 stores the second information including the information indicating the color of light to be emitted by light source 5, received by operation panel 7. Storage 62 also stores the third information generated by information processor 61. Storage 62 may be implemented using, for example, semiconductor memory or a hard disk. Storage 62 retains the second information even when luminaire 1 is powered off. It should be noted that storage 62 may be another device connected to controller 6.

Effect controller 63 controls at least the color of the light emitted by light source 5, the color being one example of a lighting state of light-emitting devices 52 in light source 5. In other words, effect controller 63 changes the color of the light emitted by light source 5 in accordance with the colors corresponding to the sequential order indicated by the stored second information.

Effect controller 63 further controls a first value indicating at least one of a brightness, hue, vividness, and transition period of the light emitted by light source 5. When the first value is changed to the second value in response to a user operating operation panel 7, effect controller 63 changes the light emitted by light source 5 based on the second value.

The first value is, for example, a first brightness, first hue, first vividness, and/or first transition period of light. The second value is different from the first value, and is, for example, a second brightness, second hue, second vividness, and/or second transition period of light.

For example, to change the brightness of the light emitted by light source 5 from a first brightness to a second brightness, effect controller 63 changes the dimming rate of the light emitted by light source 5 to the second value. For example, to change the hue of the light emitted by light source 5 from a first hue to a second hue, effect controller 63 adjusts the color of the light emitted by light source 5 to the second value. For example, to change the vividness of the light emitted by light source 5 from a first vividness to a second vividness, effect controller 63 adjusts the light emitted by light source 5 to the second value.

Effect controller 63 continuously changes the color of the light emitted by light source 5 from a first color to a second color over a predetermined transition period. In response to an operation made on operation panel 7, effect controller 63 sets the transition period according to the operation. Moreover, settings relating to the playback time for a single cycle can be appropriately changed by an operation made on operation panel 7.

Obtainer 64 obtains the first information from option box 150. Obtainer 64 provides the first information to information processor 61. Obtainer 64 is a communication interface, and is electrically connected to option box 150 via joint box 130.

Even when luminaire 1 is powered off, the second information and the third information are retained. Once luminaire 1 is powered back on, the color of the light emitted by light source 5 is changed in the sequential order stored according to the second information and the third information. Stated differently, once the second information and the third information are generated, they are not lost even if luminaire 1 is powered off.

During operation of operation panel 7, controller 6 causes light source 5 to emit light and stores the second information based on an instruction from operation panel 7 into storage 62. More specifically, during operation of the light emission buttons by the user, effect controller 63 causes light source 5 to emit light in the colors corresponding to the sequential order in which the light emission buttons were selected and at the set brightness, and information processor 61 stores the second information according to the operations made on operation panel 7 into storage 62. Accordingly, controller 6 performs the processes for the storing of the second information and the lighting of light source 5 in parallel.

Operation panel 7 is a panel via which the lighting state of luminaire 1 can be set, i.e. a panel that receives information indicating a color of light to be emitted by light source 5. Operation panel 7 includes a plurality of buttons that correspond one-to-one with different colors (first light emission button 71 through seventh light emission button 77 in this embodiment) and are operable by a user to cause light source 5 to emit light in the different colors. Operation panel 7 instructs controller 6 to control the color of the light emitted by light source 5. Operation panel 7 is one example of a user interface.

Operation panel 7 includes a plurality of light emission buttons, display 171, two level buttons 172, hue button 173, brightness button 174, pastel button 175, speed button 176, and resume button 177. In this embodiment, the plurality of light emission buttons are first light emission button 71 through seventh light emission button 77. Hereinafter, when collectively referring to first light emission button 71 through seventh light emission button 77 or when referring to any given one of first light emission button 71 through seventh light emission button 77, the term “light emission button” will simply be used.

First light emission button 71 is a button for causing light source 5 to emit red light. Red light is indicated as preset color (a) in FIG. 5. Second light emission button 72 is a button for causing light source 5 to emit yellow light. Yellow light is a mix of red and green light, and is indicated as preset color (b) in FIG. 5. Third light emission button 73 is a button for causing light source 5 to emit green light. Green light is indicated as preset color (c) in FIG. 5. Fourth light emission button 74 is a button for causing light source 5 to emit cyan light. Cyan light is a mix of green and blue light, and is indicated as preset color (d) in FIG. 5. Fifth light emission button 75 is a button for causing light source 5 to emit blue light. Blue light is indicated as preset color (e) in FIG. 5. Sixth light emission button 76 is a button for causing light source 5 to emit magenta light. Magenta light is a mix of red and blue light, and is indicated as preset color (f) in FIG. 5. Seventh light emission button 77 is a button for causing light source 5 to emit white light. White light is a mix of red, green, and blue light, and is indicated as preset color (g) in FIG. 5. First light emission button 71 through seventh light emission button 77 are each one example of a button.

Level buttons 172 are buttons that can change the hue, brightness, vividness, and transition period levels for the light emitted by light source 5. Level buttons 172 include a button for increasing and a button for decreasing the hue, brightness, and vividness levels of the light emitted by light source 5. The buttons for increasing and decreasing the levels included in level buttons 172 also change the length of the transition period. Level buttons 172 are each one example of a button.

Display 171 is a panel that displays the hue, brightness, vividness, and transition period of the light emitted by light source 5. Display 171 is, for example, a seven-segment display or liquid crystal display.

Hue button 173 is a button capable of changing the current settings related to the colors corresponding to first light emission button 71 through seventh light emission button 77. For example, using first light emission button 71 as an example, when a user wants to change the color of light corresponding to the first button to yellow, the user can select hue button 173 and change the color of the light using level buttons 172. In such cases, controller 6 updates the second information to reflect that the color of light corresponding to the first button is yellow, and stores the updated second information in storage 62. It should be noted that the colors of light corresponding to second light emission button 72 through seventh light emission button 77 can also be changed in a similar manner. Hue button 173 is one example of a button.

Brightness button 174 is a button capable of changing settings relating to the brightness of the light emitted by light source 5. For example, taking an example in which only first light emission button 71 and second light emission button 72 are selected, when a user wants to change the brightness of the light emitted by light source 5, the user selects brightness button 174 and changes the brightness of light using level buttons 172 to change the settings relating to the brightness of the light emitted by light source 5. When the brightness of the light emitted by light source 5 and corresponding to first light emission button 71 and second light emission button 72 is set in this manner, controller 6 updates the second information and stores the updated second information in storage 62. Brightness button 174 is one example of a button.

It should be noted that brightness button 174 changes the brightness setting for all light emitted by light source 5 simultaneously, and does not individually set the brightness for each color of light corresponding to the different light emission buttons.

Pastel button 175 is a button capable of changing settings relating to the vividness of light emitted by light source 5, and is for setting a neutral color. For example, using first light emission button 71 as an example, when a user wants to change the vividness of the light emitted by light source 5, the user can select pastel button 175 and change the vividness of the light using level buttons 172. When the vividness of the light emitted by light source 5 and corresponding to first light emission button 71 is set in this manner, controller 6 updates the second information and stores the updated second information in storage 62. Pastel button 175 is one example of a button.

Speed button 176 is a button capable of changing settings relating to the length of one cycle. For example, using first light emission button 71 as an example, when a user wants to change the length of one cycle, the user selects speed button 176 and changes the length of one cycle using level buttons 172. It is possible to set the length in units of seconds or minutes using level buttons 172. When the length of one cycle is set in this manner, controller 6 updates the second information and stores the updated second information in storage 62. Speed button 176 is one example of a button.

Resume button 177 is a button for reproducing the second information stored in storage 62 or turning of light source 5.

Next, the cancelling of a light emission button will be described by way of example. FIG. 7 illustrates the case in which magenta light is cancelled from the second information. It should be noted that the case in which magenta light is cancelled from the second information is illustrated, but the same is true of the first information and the third information, and the colors of light included in the first information and the third information in the chromaticity diagram can be cancelled.

As illustrated in FIG. 7, when first light emission button 71, sixth light emission button 76, and third light emission button 73 are selected in the stated order, and sixth light emission button 76 is subsequently selected again, information processor 61 cancels the emission of light in the color corresponding to sixth light emission button 76. In this case, as a result, it will be as if first light emission button 71 and third light emission button 73 are selected in the stated order. Moreover, in this case, as a result of sixth light emission button 76 being canceled, the sequence value for third light emission button 73 selected after the canceled sixth light emission button 73 is advanced by 1. In other words, effect controller 63 generates the second information for one cycle that associates red light corresponding to first light emission button 71 and green light corresponding to third light emission button 73 with the stated order, and stores the generated second information in storage 62. With luminaire 1, light is iteratively emitted while continuously changing between red and green. It should be noted that this is merely one, non-limiting example. The term “continuously changing” means that the color of light continuously changes in such a manner that the color shifts over a predetermined period of time along a line from point A1 to point A2 in the chromaticity diagram of FIG. 6A.

Here, the configuration of luminaire 1 is described again. As illustrated in FIG. 3, light-transmissive panel 8 is a panel with light transmitting properties that transmits light emitted by light source 5. Light-transmissive panel 8 is arranged on the X axis positive direction end of housing 3. Light-transmissive panel 8 covers light source 5 in a view of luminaire 1 from the X axis positive direction side of luminaire 1.

The power supply unit is a power supply circuit electrically connected to light source 5, and forms the power supply for luminaire 1. For example, the power supply unit includes a printed circuit board and electronic components mounted on the printed circuit board. The power supply unit also includes, for example, a dimming circuit and a step-up circuit as assemblies.

### (Operations)

Next, operations performed by luminaire 1 according to this embodiment will be described.

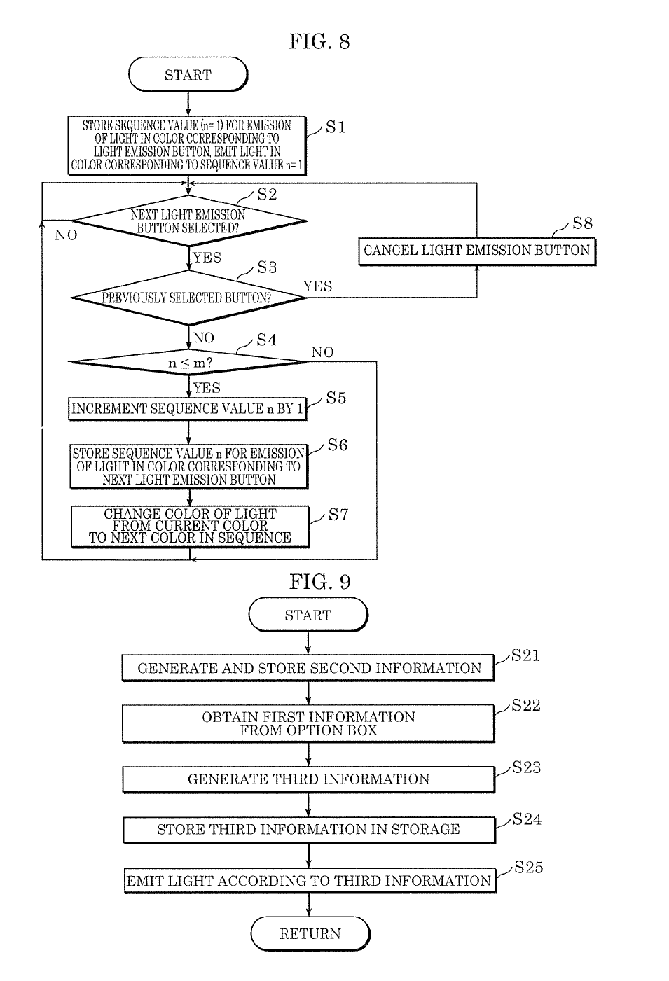

FIG. 8 is a flow chart of operations for generating the second information, performed by luminaire 1 according to the embodiment. FIG. 8 describes a user configuring settings for choreographed lighting via luminaire 1.

As illustrated in FIG. 8, first, the user powers on luminaire 1 so as to activate luminaire 1. The user selects a light emission button on operation panel 7. Information processor 61 in controller 6 stores into storage 62 the sequence value for emission of light in the color corresponding to the selected button (S1). Information processor 61 generates second information including the color of light corresponding to the light emission button and the sequence value associated with this color, and stores the generated second information in storage 62.

Effect controller 63 in controller 6 causes light source 5 to emit light in the color corresponding to the selected light emission button (S1). Upon a light emission button being selected, controller 6 causes light source 5 to emit light in the color corresponding to the light emission button and stores the second information generated at the same time as the light emission button is selected or approximately the same time into storage 62.

Next, the user selects the next light emission button. Information processor 61 determines whether the next light emission button has been selected or not based on whether information is obtained as a result of a light emission button being selected or not (S2).

When the next light emission button has not been selected (NO in S2), information processor 61 returns to step S2.

When the next light emission button has been selected (YES in S2), information processor 61 determines whether the light emission button selected in step S1 has been pressed once again or not (S3).

When the same light emission button has already been selected (YES in S3), information processor 61 cancels the color of light corresponding to the pressed light emission button (S8). Information processor 61 cancels the color of light corresponding to the selected light emission button from the second information stored in storage 62, and advances the sequence values after the color of light corresponding to the canceled light emission button by the number of light emission buttons canceled. Information processor 61 stores the second information changed due to the cancel into storage 62. Information processor 61 then returns to step S2.

When the same light emission button has not already been selected (NO in S3), this means that a light emission button different from the already selected light emission button(s) was selected, so information processor 61 determines whether sequence value n is less than or equal to maximum sequence value m (S4). In this embodiment, since there are seven light emission buttons, the maximum sequence value that can be set is m=7.

If sequence value n is less than or equal to maximum sequence value m (YES in S4), information processor 61 increments the sequence value n determined in step S1 by 1 (S5). In this case, sequence value n=2, which is the sequence value for the light emission button selected at YES in step S2.

If sequence value n is not less than or equal to maximum sequence value m (NO in S4), information processor 61 cancels the selected light emission button, and stores the second information changed due to the cancel into storage 62. Information processor 61 then returns to step S2. This means that all light emission buttons have been selected. In such cases, if a selected light emission button is canceled, the sequential order in which the colors of light corresponding to the light emission buttons are emitted can be changed. It should be noted that a light emission button can be canceled even at times when not all of the light emission buttons have been selected; so long as one or more light emission buttons have been selected, a selected light emission button can be canceled.

Next, information processor 61 updates the second information stored in storage 62 in step S1 with information associating sequence value n=2 determined in step S5 with the color of light corresponding to the subsequent light emission button selected in step S2, so as to achieve a lighting state in which light is emitted in colors corresponding to the light emission buttons, in the sequential order. The updated second information is stored in storage 62 (S6).

Next, information processor 61 continuously changes the color of the light emitted by light source 5, from the current color to the next color in the sequential order (S7). Then, since the user may press another light emission button, information processor 61 returns to step S2 and repeats the same processes.

With luminaire 1, when a light emission button is selected, controller 6 reproduces the second information, making it possible to emit light in the set lighting state.

Next, the setting of the color of the light emitted by luminaire 1 will be described in detail.

FIG. 9 is a flow chart of the setting of the color of the light emitted by luminaire 1 according to this embodiment.

First, luminaire 1 generates the second information. In response to a user operating operation panel 7, the second information according to which luminaire 1 emits light is generated via operation panel 7. Operation panel 7 stores the generated second information in storage 62 (S21). Step S21 corresponds to a step of receiving the color of light and a step of storing the second information.

Next, luminaire 1 obtains the first information from option box 150 (S22). Controller 6 of luminaire 1 obtains the first information from option box 150 via obtainer 64. Step S22 corresponds to a step of obtaining the first information.

Next, information processor 61 of controller 6 generates the third information based on the first information obtained via obtainer 64 and the second information stored in storage 62 (S23). In other words, information processor 61 mixes the color of light indicated by the first information with the color of light indicated by the second information to generate the third information. Step S23 corresponds to a step of generating the third information.

Next, information processor 61 stores the generated third information in storage 62 (S24).

Next, effect controller 63 causes light source 5 to emit light according to the third information. In other words, effect controller 63 causes light source 5 to emit light in the sequential order, in which light emission buttons are selected, indicated by the third information (S25). Step S25 corresponds to a step of causing light source 5 to emit light. Controller 6 then ends this processing.

This processing will be described by way of example. When a user selects first light emission button 71, sixth light emission button 76, and third light emission button 73 in the stated order, controller 6 causes light source 5 to emit light in colors corresponding to these light emission buttons, i.e. red, magenta, and green in the stated order. Controller 6 also generates the second information for causing light source 5 to emit light in colors of red, magenta, and green in the stated order, stores the generated second information in storage 62. Then, effect controller 63 continuously changes the color of the light emitted by light source 5 from red to magenta over a predetermined transition period, continuously changes from magenta to green over a predetermined transition period, and further continuously changes from green to red over a predetermined transition period. This single cycle of a string of three changes is repeated.

### (Operational Advantages)

Next, operational advantages of luminaire 1, lighting system 10, and the lighting control method according to this embodiment will be described.

As described above, luminaire 1 according to this embodiment produces choreographed lighting. Luminaire 1 includes: light source 5 configured to emit light in a plurality of different colors; controller 6 that controls a color of the light emitted by light source 5; operation panel 7 that receives information indicating a second color of light to be emitted by light source 5; and obtainer 64 that obtains from an external device first information indicating a first color of light to be emitted by the light source. Controller 6 stores second information including the information indicating the second color of light to be emitted by light source 5, received by operation panel 7. Controller 6 generates third information indicating a third color which is a mixture of the first color of light indicated by the first information and the second color of light indicated by the information included in the second information, and causes light source 5 to emit light using the third information.

With this, controller 6 stores the second information for causing the color of the light emitted by light source 5 to be changed, received via operation panel 7. Controller 6 mixes the color of light indicated by the first information with the color of light indicated by the second information to generate the third information. Accordingly, luminaire 1 can automatically obtain the third information without setting the choreographed lighting according to the color of light indicated by the third information.

Therefore, it is possible to simplify the configuration of settings for choreographed lighting of luminaire 1.

In particular, the load on luminaire 1 can be reduced since the third information is not set through operation panel 7.

Furthermore, lighting system 10 according to this embodiment includes: a plurality of luminaires 1; and control terminal 160, as the external device, that controls the plurality of luminaires 1.

Furthermore, control terminal 160 in lighting system 10 according to this embodiment, transmits the first information to the plurality of luminaires.

With this, luminaire 1 can simplify the obtaining of the first information. Accordingly, the third information is generated not using uniquely determined information, but according to a feeling or preference of a user, surrounding environments, etc.

Furthermore, the lighting control method according to this embodiment is for producing choreographed lighting. The lighting control method includes: receiving a color of light to be emitted by light source 5; obtaining first information from an external device; storing second information indicating the color of light received; mixing a first color of light indicated by the first information with a second color of light indicated by the second information to generate third information; and causing light source 5 to emit light using the third information.

Furthermore, the lighting control method according to this embodiment further includes displaying a point in a chromaticity diagram which defines the color of light indicated by the second information. In this case, luminaire 1 may include display 171. Furthermore, at least one of the first, second, and third information may be displayed on display 171. In doing so, the position indicated by the at least one of the first, second, and third information may be represented as coordinate values, or in the chromaticity diagram.

Furthermore, in lighting control method according to this embodiment, the second information is represented as a plurality of points in a chromaticity diagram each of which defines the color of light to be emitted by light source 5, and the lighting control method includes generating the third information in which a position of at least one of the plurality of points of the second information in the chromaticity diagram is changed, when the first color of light indicated by the first information is mixed with second colors of light indicated by the second information.

Furthermore, in lighting control method according to this embodiment, the second information is represented as a plurality of points in a chromaticity diagram each of which defines the color of light to be emitted by light source 5, and the lighting control method comprises generating the third information in which the number of the plurality of points of the second information in the chromaticity diagram is changed, when the first color of light indicated by the first information is mixed with second colors of light indicated by the second information.

Furthermore, in lighting control method according to this embodiment, the first information is information indicating the first color of light associated with weather and season in advance.

These also achieve the same operational advantages as described above.

Furthermore, operation panel 7 in luminaire 1 according to this embodiment includes the user interface includes a plurality of buttons that correspond one-to-one with different colors and are operated by a user to cause light source 5 to emit light in the plurality of different colors. Controller 6 stores the second information that associates multiple second colors of light with a sequential order in which the plurality of buttons are selected.

With this configuration, when multiple buttons are selected, controller 6 can generate the second information that associates the color of light with the sequential order in which buttons are selected. Accordingly, with luminaire 1, it is possible to simplify the setting for the second information.

Furthermore, in luminaire 1 according to this embodiment, the second information is represented as a plurality of points in a chromaticity diagram each of which defines the second color of light to be emitted by light source 5. Multiple third colors indicated by the third information are represented by changing a position of at least one of the plurality of points of the second information in the chromaticity diagram.

With this configuration, controller 6 generates the third information in which a position of at least one of the points of the second information in the chromaticity diagram is changed, by mixing the color of light indicated by the first information is mixed with the colors of light indicated by the second information. Accordingly, controller 6 can generate the third information different from the first and second information. Therefore, it is possible to simplify the configuration of settings for choreographed lighting.

Furthermore, in luminaire 1 according to this embodiment, the second information is information indicating x kinds of colors of light to be emitted by light source 5, where x is one or more. Multiple third colors indicated by the third information are represented by changing the number of the plurality of points of the second information in the chromaticity diagram.

With this configuration, controller 6 generates the third information in which the number of the points of the second information in the chromaticity diagram is changed, by mixing the color of light indicated by the first information with the colors of light indicated by the second information. Accordingly, controller 6 can generate the third information different from the first and second information. Therefore, it is possible to simplify the configuration of settings for choreographed lighting.

Furthermore, in luminaire 1 according to this embodiment, the first information is information indicating the first color of light associated with weather and season in advance.

With this configuration, the second information is changed based on the first information corresponding to the color of light associated with weather such as rainy, windy, sunny, cloudy, snowy, etc., and the color of light associated with season such as spring, summer, autumn, winter, etc. Accordingly, it is possible to simplify the setting for causing luminaire 1 to emit light in colors corresponding to the weather and season.

Furthermore, in luminaire 1 according to this embodiment, the third information is represented as a plurality of points in a chromaticity diagram each of which defines the color of the light to be emitted by light source 5. Controller 6 continuously changes the color of the light emitted by light source 5 from a first point to a second point different from the first point among the plurality of points of the third information in the chromaticity diagram.

### (Other Variations, Etc.)

Hereinbefore, a luminaire, lighting system, and lighting control method according to the present disclosure has been described based on an embodiment, but the present disclosure is not limited to the embodiment described above.

For example, in the luminaire, lighting system, and lighting control method according to the embodiment, the option box uses a table to provide the first information indicating the color of light to be emitted by the light source corresponding to the weather and season, but the option box may simply provide information indicating the weather and season to the luminaire. In this case, the controller of the luminaire may have a table indicating the color of light to be emitted from the light source corresponding to the weather and season, and generate, based on the table, the first information indicating the color of light to be emitted by the light source corresponding to the weather sensed by a weather sensor and the season calculated by a clock.

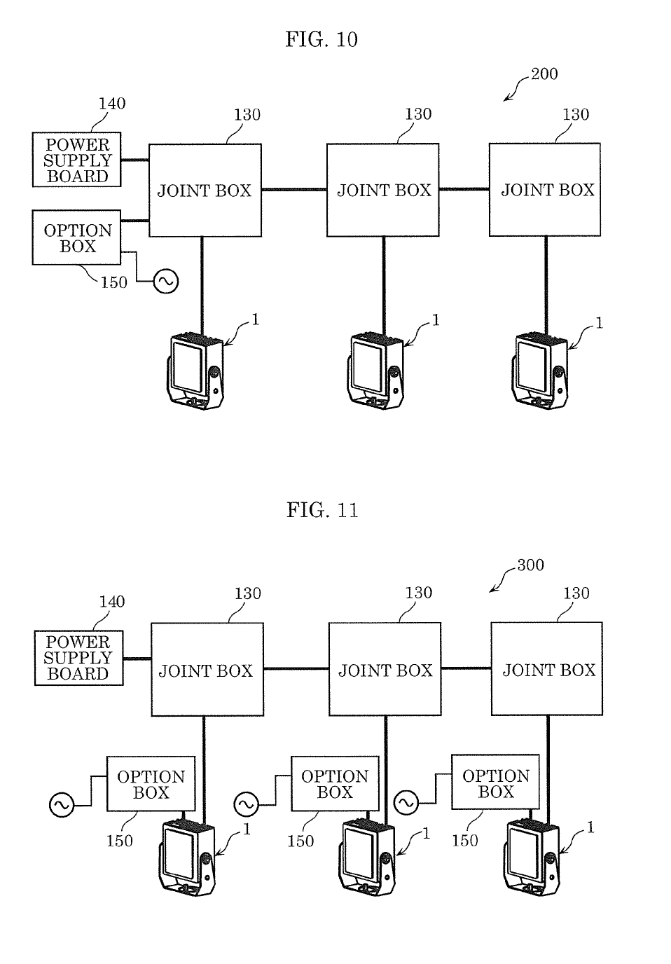

Furthermore, in the luminaire, lighting system, and lighting control method according to the embodiment, the option box and the control terminal may be changed as needed. FIG. 10 is a block diagram of lighting system 200 according to a variation. FIG. 11 is a block diagram of lighting system 300 according to another variation. As illustrated in FIG. 10, lighting system 200 may include no control terminal. Furthermore, as illustrated in FIG. 11, in lighting system 300, each option box 150 may be connected to a different one of luminaires 1.

Furthermore, in the luminaire, lighting system, and lighting control method according to the embodiment, the control terminal may be able to generate the first information. The control terminal may be one example of an external device.

Furthermore, in the embodiment described above, all of or a part of the elements of the controller may be configured in the form of specialized hardware, or may be realized by executing a software program suitable for each of the elements. Each element may be realized by a program executing unit, such as a central processing unit (CPU) or a processor, reading and executing the software program recorded on storage such as a hard disk drive (HDD) or semiconductor memory.

Furthermore, the elements of the controller may be configured in one or more electronic circuits. The one or more electronic circuits may be each a general-purpose circuit or a dedicated circuit.

The one or more electronic circuits may include, for example, a semiconductor device, an integrated circuit (IC), or a large scale integration (LSI). The IC or LSI may be integrated into a single chip or multiple chips. Due to a difference in the degree of integration, the electronic circuit referred here to as an IC or LSI may be referred to as a system LSI, very large scale integration (VLSI), or ultra large scale integration (ULSI). Furthermore, a field programmable gate array (FPGA) which programmable after manufacturing of the LSI can be used for the same purposes.

Furthermore, these general and specific aspects may be implemented using a system, a device, a method, an integrated circuit, or a computer program. Alternatively, these may be implemented using a non-transitory computer-readable recording medium such as an optical disk, HDD, or semiconductor memory storing the computer program. Furthermore, these may be implemented using any combination of systems, devices, methods, integrated circuits, computer programs, or recording media.

Embodiments arrived at by a person skilled in the art making various modifications to the embodiment as well as embodiments realized by arbitrarily combining structural components and functions in the embodiment which do not depart from the essence of the present disclosure are included in the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A luminaire that produces choreographed lighting, the luminaire comprising:
a light source configured to emit light in a plurality of different colors;
a controller that controls a color of the light emitted by the light source;
a user interface that receives information indicating a second color of light to be emitted by the light source; and
an obtainer that obtains from an external device first information indicating a first color of light to be emitted by the light source, wherein
the controller:
stores second information including the information indicating the second color of light to be emitted by the light source, received by the user interface;
generates third information indicating a third color which is a mixture of the first color of light indicated by the first information and the second color of light indicated by the information included in the second information; and
causes the light source to emit light using the third information.

2. The luminaire according to claim 1, wherein
the user interface includes a plurality of buttons that correspond one-to-one with different colors and are operated by a user to cause the light source to emit light in the plurality of different colors, and
the controller stores the second information that associates multiple second colors of light with a sequential order in which the plurality of buttons are selected.

3. The luminaire according to claim 1, wherein
the second information is represented as a plurality of points in a chromaticity diagram each of which defines the second color of light to be emitted by the light source, and
multiple third colors indicated by the third information are represented by changing a position of at least one of the plurality of points of the second information in the chromaticity diagram.

4. The luminaire according to claim 1, wherein
the second information is represented as a plurality of points in a chromaticity diagram each of which defines the second color of light to be emitted by the light source, and
multiple third colors indicated by the third information are represented by changing the number of the plurality of points of the second information in the chromaticity diagram.

5. The luminaire according to claim 1, wherein
the first information is information indicating the first color of light associated with weather and season in advance.

6. The luminaire according to claim 1, wherein
the third information is represented as a plurality of points in a chromaticity diagram each of which defines the color of the light to be emitted by the light source, and
the controller continuously changes the color of the light emitted by the light source from a first point to a second point different from the first point among the plurality of points of the third information in the chromaticity diagram.

7. A lighting system, comprising:
a plurality of luminaires each of which is the luminaire according to claim 1; and
a control terminal, as the external device, that controls the plurality of luminaires.

8. The lighting system according to claim 7, wherein
the control terminal transmits the first information to the plurality of luminaires.

9. A lighting control method of producing choreographed lighting, the lighting control method comprising:
receiving a color of light to be emitted by a light source;
obtaining first information from an external device;
storing second information indicating the color of light received;
mixing a first color of light indicated by the first information with a second color of light indicated by the second information to generate third information; and
causing the light source to emit light using the third information.

10. The lighting control method according to claim 9, further comprising:
displaying a point in a chromaticity diagram which defines the color of light indicated by the second information.

11. The lighting control method according to claim 9, wherein
the second information is represented as a plurality of points in a chromaticity diagram each of which defines the color of light to be emitted by the light source, and
the lighting control method comprises generating the third information in which a position of at least one of the plurality of points of the second information in the chromaticity diagram is changed, when the first color of light indicated by the first information is mixed with second colors of light indicated by the second information.

12. The lighting control method according to claim 9, wherein
the second information is represented as a plurality of points in a chromaticity diagram each of which defines the color of light to be emitted by the light source, and
the lighting control method comprises generating the third information in which the number of the plurality of points of the second information in the chromaticity diagram is changed, when the first color of light indicated by the first information is mixed with second colors of light indicated by the second information.

13. The lighting control method according to claim 9, wherein
the first information is information indicating the first color of light associated with weather and season in advance.
